(19) United States
(12) Patent Application Publication
(10) Pub. No.: US 2010/0222500 A1
(43) Pub. Date: Sep. 2, 2010

(54) Dispersing Agent for Aqueous Pigment Preparations

(76) Inventors: Hendrik Ahrens, Kriftel (DE); Bjoern Fechner, Eppstein (DE); Uwe Bechtold, Frankfurt am Main (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/223,054

(22) PCT Filed: Jan. 10, 2007
(86) PCT No.: PCT/EP2007/000141

§ 371 Date: Apr. 14, 2009

(30) Foreign Application Priority Data
Jan. 20, 2006 (DE) 10 2006 002 800.7

(51) Int. Cl. C09B 67/00; C08K 5/00; C08K 5/42; C08K 5/5317; C08K 5/098; C08G 65/26

(52) U.S. Cl. 524/577; 106/493; 106/494; 106/503; 106/505; 528/393

(57) ABSTRACT

The invention relates to aqueous pigment preparations containing at least one organic and/or inorganic pigment, as well as dispersing agent that comprises or more structural units of the formula (I)

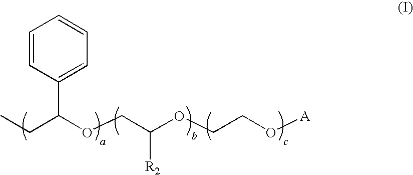

which are bound to a structural unit Y. In formula (I), a represents an integer from 1 to 100, b represents an integer from 0 to 100, c represents an integer from 1 to 100, units a, b, and c can be arranged statistically or in blocks, R₂ represents an aliphatic, linear or branched hydrocarbon radical having 1 to 30 carbon atoms, A represents hydrogen or an anionic radical of the formulae —SO₃M, —SO₂M, —PO₃M₂, —CH₂COOM or (II), and

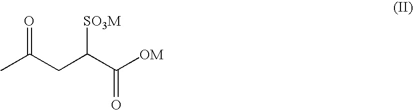

M represents a hydrogen atom, a cation from the group Na⁺, K⁺, NH₄⁺, ethanolammonium, diethanolammonium or triethanolammonium, or a secondary, tertiary or quaternary, alkyl-substituted ammonium ion that is substituted with alkyl groups, or a combination thereof. Structural unit Y represents a carbon-containing structural unit which can alkoxylate at least at two bonding points that are formed by one or several nitrogen atoms, one or more oxygen atoms, or both.

The present invention relates to dispersants for water-based pigment preparations and to their use for coloring macromolecular materials of all kinds, such as fiber materials, paper, and plastics, for example, and also for coloring coating materials, paints, and inks, and additionally for printing two-dimensional sheetlike structures such as paper, cardboard packaging, plastic, textiles, and leather, for example.

The prior art has disclosed a variety of dispersants.

DE-A-4 134 967 describes block copolymers of type A-B whose block A is formed by polymerization of compounds containing vinyl groups and whose block B is a polyoxyalkylene block, obtainable by first subjecting monomers containing vinyl groups to free-radical polymerization at temperatures from 60 to 150° C. in the presence of sufficient amounts of an initiator and of amounts, corresponding to the desired chain length, of a chain regulator which as well as a mercapto group also carries a further functional group containing at least one active hydrogen radical, reacting the resulting polymer, where the functional group having an active hydrogen radical is an OH or COOH group, with alkali metal hydroxide or alkali metal alkoxide, with removal of water or alcohol, respectively, and subjecting the polymer modified accordingly to addition reaction with alkylene oxide, at temperatures from 20 to 180° C., until the desired molar weight of the block B is reached.

EP-A-1 078 946 describes block-copolymeric polyalkylene oxides of the formula R¹O(SO)ₐ(EO)_{b}(PO)_{c}(BO)_{d}R² (I), where R¹ is a straight-chain or branched or cycloaliphatic radical having 8 to 13 carbon atoms, R² is hydrogen, an acyl radical, alkyl radical or carboxylic acid radical having in each case 1 to 8 C atoms, SO is styrene oxide, EO is ethylene oxide, PO is propylene oxide, BO is butylene oxide, and a is 1 to 1.9, b is 3 to 50, c is 0 to 3, and

d is 0 to 3, with a, c or d being other than 0, and b being >=a+c+d. EP-A-0 940 406 discloses phosphoric esters
a) which are obtainable by reaction of an ω-hydroxy-functional oligo- or poly(alkyl)styrene with an alkylene oxide to give a poly(alkyl)styrene-block(b)-polyalkylene oxide copolymer and subsequent conversion into the corresponding phosphoric esters with a phosphorus compound that forms phosphoric esters, up to 100% of the terminal hydroxyl groups of these poly(alkyl)styrene-block(b)-polyalkylene oxide copolymers being converted into phosphoric ester groups, and the phosphorus atoms being singly and/or doubly esterified depending on the chosen stoichiometric proportions,
or
b) based on polystyrene oxide-block(b)-polyalkylene oxide copolymers which are obtainable starting from a monofunctional starter alcohol by sequential addition of styrene oxide and an alkylene oxide in accordance with the desired sequence and chain length of the individual segments, and subsequently reacted to form the corresponding phosphoric esters, as described in a).

It was an object of the present invention to provide new dispersants allowing the production of aqueous pigment preparations which meet the following profile of requirements: the pigment preparations ought to possess a high shear stability and/or flocculation stability. The concentration of the pigments in the preparations ought to be as high as possible and ought preferably to be at least 20% by weight. The pigment preparations are to possess a high color strength and low viscosity and have only a low tendency to foam. A storage stability of at least two years is the target—in other words, the dispersed pigments ought not to agglomerate and settle within that time. Moreover, the dispersant ought to be free of alkylphenol derivatives and ought not to contain substantial volatile constituents.

Surprisingly it has been found that, using copolymers of styrene oxide, alkylene oxides, and alcohols and amines with a functionality of two or more, it is possible to produce aqueous pigment preparations which meet the requirements addressed above. The aqueous pigment dispersions thus produced are shear-resistant, storage-stable, foam little or not at all in application, and possess a low viscosity.

The invention accordingly provides aqueous pigment preparations comprising
(A) at least one organic and/or inorganic pigment,
(B) at least one dispersant comprising 2 or more structural units of the formula I

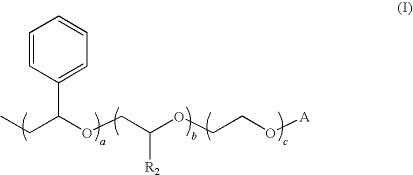

which are attached to a structural unit Y, and in which
a is an integer from 1 to 100,
b is an integer from 0 to 100,
c is an integer from 1 to 100,
   and the units a, b, and c may be arranged randomly or blockwise,
R₂ is an aliphatic, linear or branched hydrocarbon radical having 1 to 30 carbon atoms,
A is hydrogen or an anionic radical of the formulae —SO₃M, —SO₂M, —PO₃M₂, —CH₂COOM or (II), and

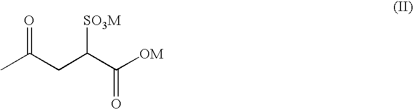

M is a hydrogen atom, a cation from the group Na⁺, K⁺, NH₄⁺, ethanolammonium, diethanolammonium or triethanolammonium, or a secondary, tertiary or quaternary, alkyl-substituted ammonium ion, or a combination thereof,
   the structural unit Y being a carbon-containing structural unit capable of alkoxylation at not less than two bond sites, and these bond sites are formed by one or more nitrogen atoms, one or more oxygen atoms, or both.

The invention further provides for the use of at least one dispersant (B) for dispersing at least one organic and/or inorganic pigment in water.

The invention further provides a method of dispersing at least one organic and/or inorganic pigment in water, by adding at least one dispersant (B) to the mixture of organic and/or inorganic pigment and water.

The structural unit Y is preferably derived from dihydric or polyhydric alcohols, monoamines or polyamines, or from amino alcohols, the latter containing at least one amino group and at least one OH group. They may be aromatic or aliphatic. They may be monomeric, oligomeric or polymeric. The number of OH groups they contain is preferably at least 2, more particularly 2 to 30, especially 3 to 15. “Derived” means that the structural unit Y comes about by formal abstraction of hydrogen atoms from the alcohol and/or amine groups. The structural unit Y is capable of alkoxylation at not less than two bond sites. This means that there are at least 2 sites in the structural unit Y at which alkoxy groups of the formula I can be added. These bond sites are oxygen or nitrogen atoms. Owing to the possible twofold alkoxylation of nitrogen atoms, it is sufficient for the structural unit Y to contain one nitrogen atom. Where, however, the structural unit contains no nitrogen atom, but oxygen atoms instead, then there are always at least two oxygen atoms needed that are capable of alkoxylation, in order to be able to add at least two alkoxy groups of the formula I. In a further preferred embodiment the structural unit Y contains 1 to 100, more particularly 2 to 80, carbon atoms.

a is preferably a number from 2 to 80, more particularly from 3 to 30, especially 4 to 8.
b is preferably a number from 1 to 80, more particularly from 2 to 30, especially 3 to 8.
c is preferably a number from 2 to 80, more particularly from 3 to 50, especially 5 to 20.

Preference is given to a dispersant (B) in which a is a number from 1 to 40, b is zero, and c is a number from 5 to 50.

In one preferred embodiment the dispersant (B) is of formula III

X—Y—X (III)

wherein Y is selected from structural units of the formulae IV to XIV

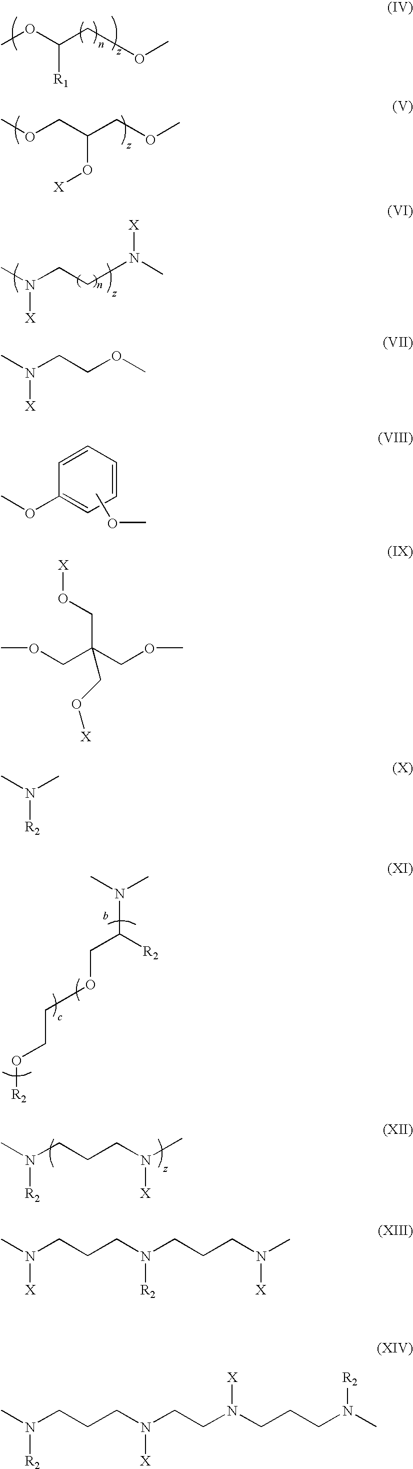

in which
R₁ is an aliphatic, linear or branched hydrocarbon radical having 1 to 30 carbon atoms, or a hydrogen atom,
z is an integer greater than or equal to 1,
n is an integer from 1 to 30, and
X is a radical of the formula I.
   n is preferably an integer from 1 to 4.
   z is preferably an integer from 1 to 30, more particularly a number from 2 to 20, especially 3.

Examples of compounds from which the structural unit Y is derived may be the following diols and polyols: monoethylene glycol, diethylene glycol, triethylene glycol, pentaethylene glycol, polyethylene glycols having a molecular weight of 200 to 12 000 g/mol, propylene glycol, dipropylene glycol, tripropylene glycol, polypropylene glycols having a molecular weight of 200 to 6000 g/mol, 1,4-butylene glycol, 1,3-butylene glycol, 1,2-butylene glycol, pentylene glycols, 1,6-hexylene glycol, cyclohexanediol, mixed polyglycols of ethylene glycol and propylene glycol or butylene glycols with molar ratios of ethylene glycol:propylene glycol or butylene glycol of 1:100 to 100:1, and also mixed polyglycols of ethylene glycol, propylene glycol, and butylene glycol, block polymers of ethylene glycol, propylene glycol, and butylene glycol with molecular weights from 500 to 12 000 g/mol, more particularly block polymers of ethylene glycol with polypropylene glycol or butylene glycol in which the weight fraction of ethylene oxide in the block polymer is 10% to 90%, triols such as glycerol, trihydroxymethylpropane, polyols such as erythritol, pentaerythritol, sorbitol, diglycerol, polyglycerols having 3 to 15 glycerol units, aromatic diols such as hydroxybenzyl alcohol, bisphenol A, pyrocatechol, resorcinol, and hydroquinone.

Further examples of compounds from which the structural unit Y is derived may be the following amines, diamines, polyamines, and hydroxyalkylamines:

fatty amines having 8 to 30 carbon atoms, such as octylamine, decylamine, cocamine, oleylamine, tallowamine, stearylamine, ethylenediamine, propylenediamine, diethylenetriamine, triethylenetetramine, tetraethylene-pentamine, polyethyleneimine, N-alkylpropylenediamine, N-alkyl-dipropylenetriamine, N,N-bis-3-aminopropylalkylamine, bis-N,N-(tallow-alkylaminopropyl)ethylenediamine, methoxypolyethoxyamines, methoxy-polyalkoxyamine (Jeffamines), ethanolamine, diethanolamine, triethanol-amine, and 2-amino-2-methylpropanol (AMP).

Besides the constituents (A) and (B) the composition of the invention may comprise further constituents. Thus in preferred embodiments the composition of the invention comprises
(C) if desired, one or more nonionic surfactants from the group of alkylphenol polyethylene glycol ethers, styrene-substituted phenol polyethylene glycol ethers, alkylpolyethylene glycol ethers, fatty acid polyethylene glycol ethers, fatty acid polyglycosides, alkyl polyalkyl glycol ethers of C₈-C₂₂ alcohols which have been reacted blockwise with ethylene oxide and propylene oxide, endgroup-capped alkyl ethoxylates of C₈-C₂₂ alcohols which have been reacted with ethylene oxide and etherified with methyl chloride, butyl chloride or benzyl chloride, ethylene/propylene glycol block copolymers, and sorbitan ester polyethylene glycol ethers;
(D) if desired, one or more anionic surfactants from the group of sodium, potassium, and ammonium salts of fatty acids, sodium alkyl-benzenesulfonates, sodium alkylsulfonates, sodium olefinsulfonates, sodium polynaphthalenesulfonates, sodium dialkyldiphenyl ether disulfonates, sodium, potassium, and ammonium alkyl sulfates, sodium, potassium, and ammonium alkylpolyethylene glycol ether sulfates, sodium, potassium, and ammonium alkylphenol polyethylene glycol ether sulfates, sodium, potassium, and ammonium mono- and dialkylsulfosuccinates, and monoalkyl polyoxyethylsulfosuccinates, and also alkyl polyethylene glycol ether phosphoric monoesters, diesters and triesters and mixtures thereof, and alkylphenol polyethylene glycol ether-phosphoric monoesters, diesters, and triesters, and mixtures thereof, and also their sodium, potassium, and ammonium salts, alkyl polyethylene glycol ether carboxylic acids and their sodium, potassium, and ammonium salts, sulfuric monoesters and phosphoric esters of styrene-substituted phenol ethoxylates, styrene-substituted phenol polyethylene glycol ether carboxylic acids and their sodium, potassium, and ammonium salts, sodium fatty acid isethionates, sodium fatty acid methyl-thaurides, and sodium fatty acid sarcosides;
(E) if desired, one or more polyethylene glycol ethers having an average molar mass between 200 and 2000 g/mol;
(F) if desired, one or more polyethylene glycol monoalkyl ethers having an average molar mass between 200 and 2000 g/mol and an alkyl radical of 1-6 carbon atoms;
(G) if desired, one or more organic solvents or one or more hydrotropic substances;
(H) if desired, further additives typical of aqueous pigment preparations;
(J) if desired, one or more preservatives; and
(K) water.

Constituents (A) to (K) are present independently of one another preferably in the following amounts:
(A) 3% to 80%, preferably 20% to 70%, more particularly 30% to 50% by weight of at least one organic and/or inorganic pigment.
(B) 0.1% to 30%, preferably 1% to 15%, by weight of at least one dispersant (B).
(C) 0% to 30%, preferably 1% to 15%, by weight of a nonionic surfactant.
(D) 0% to 30%, preferably 1% to 15%, by weight of an anionic surfactant.
(E) 0% to 50%, preferably 1% to 20%, by weight of a polyethylene glycol ether having an average molar mass between 200 and 2000 g/mol.
(F) 0% to 50%, preferably 1% to 20%, by weight of a polyethylene glycol monoalkyl ether having an average molar mass between 200 and 2000 g/mol and an alkyl radical of 1-6 carbon atoms.
(G) 0% to 30%, preferably 0% to 20%, by weight of an organic solvent or a hydrotropic substance.
(H) 0% to 10%, preferably 0% to 5%, by weight of further additives typical for aqueous pigment preparations.
(J) 0% to 2%, preferably 0.02% to 0.05%, by weight of a preservative.
(K) 5% to 90%, preferably 10% to 70%, by weight of water.

The weight percentages are based in each case on the total weight of the pigment preparation.

Where one or more of components (C), (D), (E), (F), (G), (H), and (J) are present, their minimum concentration independently of one another is judiciously at least 0.01%, preferably at least 0.1%, by weight, based on the total weight of the pigment preparation.

Component (A) of the pigment preparation is a preferably finely divided organic or inorganic pigment or a mixture of different organic and/or inorganic pigments. These pigments may be used in the form of a dry powder, in the form of granules, or else in the form of a water-moist presscake.

Suitable organic pigments include monoazo, disazo, laked azo, β-naphthol, naphthol AS, benzimidazolone, disazo condensation, and azo-metal complex pigments and polycyclic pigments such as, for example, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, and diketopyrrolo-pyrrole pigments or carbon blacks.

As an exemplary selection of particularly preferred organic pigments mention may be made of carbon black pigments, such as gas blacks or furnace blacks; monoazo and disazo pigments, more particularly the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and naphthol AS pigments, more particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo pigments and metal complex pigments, more particularly the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, more particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, more particularly the Colour Index pigments Pigment Yellow 139 or Pigment Yellow 173; phthalocyanine pigments, more particularly the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone, and thioindigo pigments, more particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, more particularly the Colour Index pigments Pigment Red 169, Pigment Blue 56 or Pigment Blue 61; diketopyrrolopyrrole pigments, more particularly the Colour Index pigments Pigment Red 254, Pigment Red 255, Pigment Red 264, Pigment Red 270, Pigment Red 272, Pigment Orange 71, Pigment Orange 73, Pigment Orange 81.

The organic pigment is preferably combined with carbon black and/or titanium dioxide.

Also suitable are laked dyes such as Ca, Mg, Al lakes of dyes containing sulfonic and/or carboxylic acid groups.

Examples of suitable inorganic pigments include titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed phase pigments, sulfides of the rare earths, spinels of cobalt with nickel and zinc, spinels based on iron and chromium with copper, zinc, and manganese, bismuth vanadates, and also extender pigments. Use is made more particularly of the Colour Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33, and Pigment White 6. Preference is also given to using, frequently, mixtures of inorganic pigments. Mixtures of organic with inorganic pigments are likewise frequently used.

Instead of pigment dispersions it is also possible to produce dispersions which comprise as solids, for example, finely divided ores, minerals, sparingly soluble or insoluble salts, particulate waxes or plastics, dyes, crop protection and pesticidal agents, biocides, herbicides, insecticides, fungicides, UV absorbers, optical brighteners or polymerization stabilizers.

Component (B) is typically used as an aqueous solution for producing the pigment preparations of the invention. Component (B) is prepared by addition and anionic polymerization of styrene oxide, ethylene oxide, propylene oxide, butylene oxide or longer-chain alkylene oxides with compounds comprising at least 2 heteroatoms selected from oxygen or nitrogen, examples being difunctional or polyfunctional alcohols or amines or amino alcohols. The alkoxylation takes place at one or more of the oxygen or nitrogen atoms of this compound, but at least at two sites in the molecule. These sites are alkoxylatable oxygen and/or nitrogen atoms, preferably alcohol and/or amino groups. The compound which is alkoxylated then forms the structural unit Y. The anionic polymerization may take place randomly or blockwise. Following the copolymerization, the nonionic dispersant (B) formed in a first stage can be modified by addition of an anionic group. Suitable anionic groups are sulfuric monoesters, which are obtainable by reacting the nonionic dispersants of the invention with amidosulfonic acid, or phosphoric esters, which can be prepared by reacting the nonionic dispersants of the invention with orthophosphoric acid, polyphosphoric acid or phosphorus pentoxide P₂O₅. It is possible, furthermore, to prepare sulfosuccinic monoesters by reacting the nonionic dispersants of the invention with maleic anhydride and sodium sulfite or sodium bisulfite, and carrying out neutralization with aqueous sodium hydroxide solution. Ethercarboxylic acids can be prepared by reacting the nonionic dispersants of the invention with monochloroacetic acid under alkaline conditions.

Corresponding to component (G) are water-soluble organic or hydrotropic substances. Compounds of this kind, which where appropriate also serve as solvents, or are oligomeric or polymeric in nature, examples being formamide, urea, tetramethylurea, ε-caprolactam, ethylene glycol, propylene glycol, diethylene glycol, triethylene glycol, polyethylene glycol, α-methyl-ω-hydroxy-polyethylene glycol ethers, dimethylpolyethylene glycol ethers, dipropylene glycol, polypropylene glycol, dimethylpolypropylene glycol ethers, copolymers of ethylene glycol and propylene glycol, butyl glycol, methylcellulose, glycerol, diglycerol, polyglycerol, N-methyl-pyrrolidone, 1,3-diethyl-2-imidazolidinone, thiodiglycol, sodium benzene-sulfonate, sodium xylenesulfonate, sodium toluenesulfonate, sodium cumenesulfonate, sodium dodecylsulfonate, sodium benzoate, sodium salicylate, sodium butyl monoglycol sulfate, cellulose derivatives, gelatin derivatives, polyvinylpyrrolidone, polyvinyl alcohol, polyvinylimidazole, and copolymers and terpolymers of vinylpyrrolidone, vinyl acetate, and vinylimidazole, the polymers containing vinyl acetate units being able subsequently to be subjected to hydrolysis to form the vinyl alcohol.

As typical additives (component H) suitability is possessed by further cationic, anionic, amphoteric or nonionic surfactants and substances that promote pigment wetting (wetting agents), and also antisettling agents, light stabilizers, antioxidants, degassers/defoamers, foam suppressants, fillers, grinding assistants, viscosity stabilizers, and additives which benefit the rheology. Suitable agents for regulating the viscosity include, for example, polyvinyl alcohol and cellulose derivatives. Water-soluble natural or synthetic resins and also polymers as film formers or binders for increasing adhesive strength and abrasion resistance are likewise suitable. pH regulators include organic or inorganic bases and acids. Preferred organic bases are amines, such as ethanolamine, diethanolamine, triethanolamine, N,N-dimethylethanolamine, diisopropylamine, aminomethylpropanol or dimethylaminomethylpropanol, for example. Preferred inorganic bases are sodium, potassium, and lithium hydroxide or ammonia.

Water utilized for producing the pigment preparations, component (K), is used preferably in the form of distilled or deionized water. Drinking water as well (mains water) and/or water of natural origin can be used. In one embodiment of the invention the pigment preparation of the invention contains the constituents (A) and (B) and also water to 100% by weight.

The pigment preparations possess good storage stability and exhibit a very low tendency toward agglomeration and toward sedimentation. The pigment preparations possess high color strengths, defined hues, and low viscosities.

The present invention also provides a process for producing the pigment preparations of the invention, which comprises dispersing component (A) in the form of powder, granules or aqueous presscake in the presence of water (K) and also of components (B) and where appropriate (C), (D), (E), (F), (G), (H), and (J), in conventional manner, then mixing in, where appropriate, water (K), and adjusting the resultant aqueous pigment dispersion to the desired concentration with water. Preferably components (B), (C), (D), (E), (F), (G), (H), (J), and (K) are mixed and homogenized, and then component (A) is stirred into the initial mixture, with the pigment being pasted up and predispersed. Depending on the harshness of grain of the pigments employed, this is followed by fine division or fine dispersion, with the aid of a milling or dispersing assembly, with cooling where appropriate. Agitator mechanisms, dissolvers (sawtooth stirrers), rotor-stator mills, ball mills, agitator ball mills such as sandmills and beadmills, high-speed mixers, kneading apparatus, roll mills or high-performance bead mills may be used for this purpose. The pigments are finely dispersed or milled until the desired particle size distribution is reached, in operations which can take place at temperatures in the range from 0 to 100° C., advantageously at a temperature between 10 and 70° C., preferably at 20 to 60° C. Following the fine dispersing the pigment preparation can be diluted further with water, preferably deionized or distilled water.

The pigment preparations produced with the dispersants of the invention are suitable for pigmenting and coloring macromolecular materials of all kinds, such as natural and synthetic fiber materials, preferably cellulose fibers, more particularly for textile coloring and textile printing.

The dispersants of the invention are free from alkylphenol and from alkylphenol ethoxylates and conform to appendix 38 of the German waste water management provisions for textile waste waters, provided the dispersants do not reduce the surface tension of water below 45 mN/m in a 0.5% solution. By controlling the degree of alkoxylation, in other words by adding a sufficient amount of styrene oxide, ethylene oxide or other alkylene oxides, the surface tension of the 0.5% strength solution can be made to remain above the 45 mN/m limit. Accordingly, the dispersants of the invention are particularly suitable for use in textile finishing, such as the dyeing of polyester fibers and other synthetic fibers and the printing of textiles such as cotton or cotton/polyester blend fabrics in a pigment printing process, for example.

The pigment preparations are suitable, furthermore, for pigmenting and/or producing colored coatings and emulsion paints, dispersion lacquers, printing inks, such as textile, flexographic, decorative or gravure printing inks, wallpaper colors, water-thinnable paints, wood preservation systems, spin coloring systems for viscose, varnishes, sausage skins, seed, fertilizers, glass bottles, and also for the mass coloring of paper and coloring of laminates, and for roof shingles, for coloring for renders, wood stains, colored pencil leads, fibertip pens, waxes, paraffins, graphics inks, ballpoint pen pastes, chalks, laundry detergents and cleaning products, shoe polishes, latex products, abrasives, and also for coloring plastics or high molecular mass materials. Examples of high molecular mass organic materials are cellulose ethers and cellulose esters, such as ethylcellulose, nitrocellulose, cellulose acetate or cellulose butyrate, natural resins or synthetic resins, such as addition polymerization resins or condensation resins, examples being amino resins, more particularly urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, latices, silicone, silicone resins, individually or in a mixture.

The pigment preparations produced with the dispersants of the invention are suitable, furthermore, for producing printing inks for use in all conventional ink-jet printers, more particularly for those based on the bubble jet or piezo process. These printing inks can be used to print paper, and also natural or synthetic fiber materials, foils, and plastics. Additionally the pigment preparations can be used to print any of a very wide variety of kinds of coated or uncoated substrate materials: for example, for printing paperboard, cardboard, wood and woodbase materials, metallic materials, semiconductor materials, ceramic materials, glasses, glass fibers and ceramic fibers, inorganic materials of construction, concrete, leather, comestibles, cosmetics, skin, and hair. The substrate material may be two-dimensionally planar or spatially extended, i.e., of three-dimensional form, and may have been coated or printed either completely or only in parts.

Further suitable applications of the dispersants of the invention are pigment preparations which are used as colorants in electrophotographic toners and developers, such as one- or two-component powder toners (also called one- or two-component developers), magnetic toners, liquid toners, latex toners, polymerization toners, and specialty toners, for example. Typical toner binders in this context are addition polymerization resins, polyaddition resins, and polycondensation resins, such as styrene, styrene acrylate, styrene butadiene, acrylate, polyester, and phenolic epoxy resins, polysulfones, polyurethanes, individually or in combination, and also polyethylene and polypropylene, which may contain further ingredients, such as charge control agents, waxes or flow assistants, or may be subsequently modified with these adjuvants.

A further possible application of the dispersants of the invention is the production of pigment preparations which are used as colorants in powders and powder coating materials, more particularly in triboelectrically or electrokinetically sprayable powder coating materials which are used to coat the surfaces of articles made, for example, of metal, wood, plastic, glass, ceramic, concrete, textile material, paper or rubber. Powder coating resins used here are typically epoxy resins, carboxyl- and hydroxyl-containing polyester resins, polyurethane resins, and acrylic resins, together with customary hardeners. Resin combinations also find use. For example, epoxy resins are frequently used in combination with carboxyl- and hydroxyl-containing polyester resins. Typical hardener components (depending on the resin system) are, for example, acid anhydrides, imidazoles, and also dicyandiamide and derivatives thereof, capped isocyanates, bisacylurethanes, phenolic resins and melamine resins, triglycidyl isocyanurates, oxazolines, and dicarboxylic acids.

The polymeric dispersants of the invention are additionally suitable for producing pigment preparations which are used as colorants in aqueous or nonaqueous inks, preferably ink-jet inks, microemulsion inks, UV-curable inks, and in those inks which operate according to the hot-melt technique.

The pigment preparations of the invention are also suitable, furthermore, as colorants for color filters for flat panel displays, both for additive and for subtractive color generation, and additionally for photoresists, and also as colorants for electronic inks (or “e-inks”) or electronic paper (or “e-paper”).

### EXAMPLES

Examples of the dispersants of the invention are the following compounds. As a starter molecule, diols, diamines or triamines were introduced as an initial charge, and the desired amount of styrene oxide and ethylene oxide was added in such a way that alkoxylation was carried out blockwise.

| | Composition | Chemical structure |
|---|---|---|
| Speci- men 1 | Monoethylene glycol +10 mol styrene oxide +40 mol ethylene oxide | 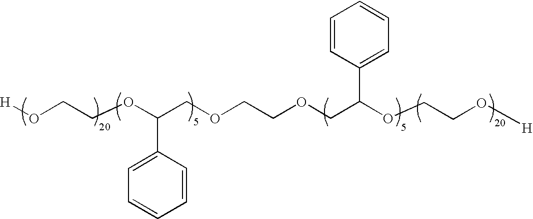 |
| Speci- men 2 | Monoethylene glycol +10 mol styrene oxide +76 mol ethylene oxide | 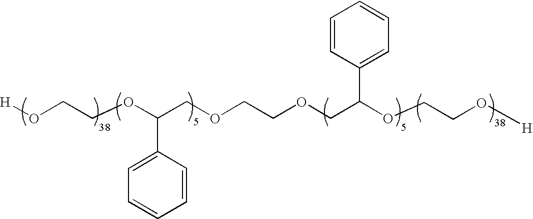 |
| Speci- men 3 | Ethylenediamine +12 mol styrene oxide +40 mol ethylene oxide | 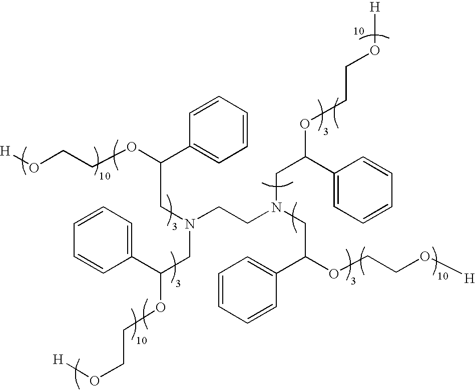 |
| Speci- men 4 | Ethylenediamine +16 mol styrene oxide +120 mol ethylene oxide | 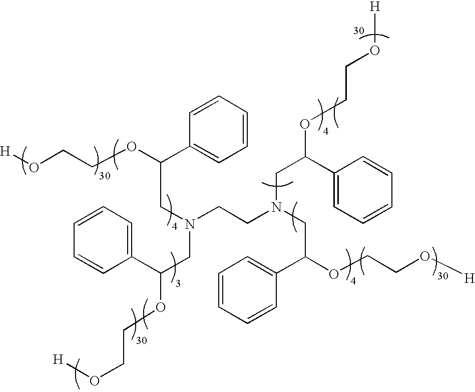 |
| Speci- men 5 | Diethylenetriamine +15 mol styrene oxide +40 mol ethylene oxide | 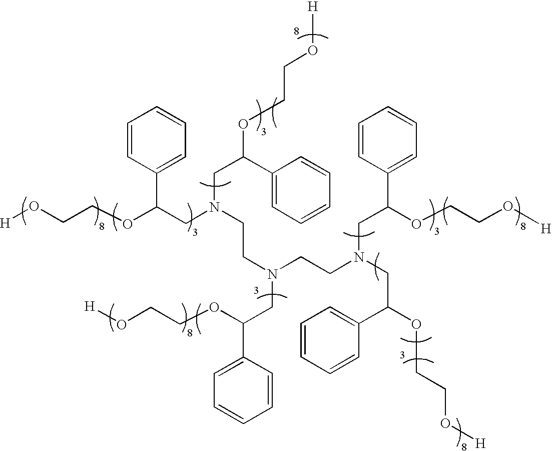 |
| Speci- men 6 | Diethylenetriamine +15 mol styrene oxide +150 mol ethylene oxide | 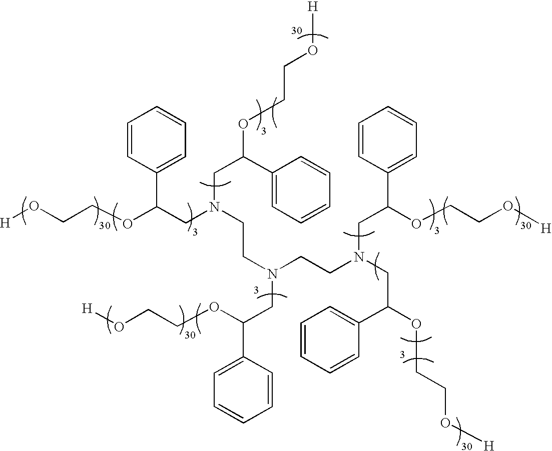 |

### Production of a Pigment Preparation

The pigment, in the form alternatively of a powder, granules or presscake, was pasted up in deionized water together with the dispersants and the other adjuvants and then homogenized and predispersed using a dissolver (e.g., from VMA-Getzmann GmbH, model CN-F2) or another suitable apparatus. Subsequent fine dispersion took place with the aid of a bead mill (e.g., APS 500 from VMA-Getzmann) or else of another suitable dispersing assembly, the grinding taking place with siliquartzite beads or zirconium mixed oxide beads with a size d=1 mm, with cooling, until the desired color strength and coloristic properties were obtained. Subsequently the dispersion was adjusted with deionized water to the desired final pigment concentration, the grinding media were separated off, and the pigment preparation was isolated.

The pigment preparations described in the examples below were produced by the method described above, the following constituents being used in the stated amounts so as to give 100 parts of the respective pigment preparation. In the examples below, parts are by weight.

### Example 1

| | | |
|---|---|---|
| 25 | parts | C.I. Pigment Black 7 (® Special Black 4, Degussa AG, |
| | | component A) |
| 4 | parts | dispersant specimen 1 (component B) |
| 2 | parts | alkylpolyalkylene glycol ether (component C) |
| 9.5 | parts | polyethylene glycol, molecular weight 200 g/mol |
| | | (component E) |
| 0.5 | part | defoamer (component H) |
| 0.2 | part | preservative (component J) |
| 58.8 | parts | demineralized water (component K) |

Components (B), (C), (E), (H), and (J) were charged to a grinding vessel and mixed. Subsequently the pulverulent component (A) was added and predispersed using the dissolver. Fine dispersion took place in a bead mill by means of zirconium mixed oxide beads of size d=1 mm with cooling. Subsequently the grinding media were separated off and the pigment preparation was isolated. The pigment preparation was stored at 60° C. for a week and inspected. The viscosity of the pigment preparation was measured using a Brookfield digital viscometer model DV-II at 100 revolutions per minute and spindle 4.

After a week of storage at 60° C. the pigment preparation was liquid, homogeneous, and foam-free. The viscosity of the pigment preparation was 15 mPa≅s.

### Example 2

| | | |
|---|---|---|
| 20 | parts | C.I. Pigment Violet 19 (® Hostaperm RedE5B 02, Clariant |
| | | GmbH, component A) |
| 4 | parts | dispersant specimen 2 (component B) |
| 2 | parts | alkylpolyalkylene glycol ether (component C) |
| 9.5 | parts | polyethylene glycol, molecular weight 200 g/mol |
| | | (component E) |
| 0.5 | part | defoamer (component H) |
| 0.2 | part | preservative (component J) |
| 63.8 | parts | demineralized water (component K) |

For the production and testing of the pigment preparation the procedure set out in Example 1 was repeated. After a week of storage at 60° C. the pigment preparation was liquid, homogeneous, and foam-free. The viscosity of the pigment preparation was 10 mPa·s.

### Example 3

| | | |
|---|---|---|
| 40 | parts | C.I. Pigment Red 146 (® Permanent Carmine FBB02, |
| | | Clariant GmbH, component A) |
| 4 | parts | dispersant specimen 3 (component B) |
| 2 | parts | alkylpolyalkylene glycol ether (component C) |
| 9.5 | parts | polyethylene glycol, molecular weight 200 g/mol |
| | | (component E) |
| 0.5 | part | defoamer (component H) |
| 0.2 | part | preservative (component J) |
| 43.8 | parts | demineralized water (component K) |

For the production and testing of the pigment preparation the procedure set out in Example 1 was repeated. After a week of storage at 60° C. the pigment preparation was liquid, homogeneous, and foam-free. The viscosity of the pigment preparation was 53 mPa·s.

### Example 4

| | | |
|---|---|---|
| 40 | parts | C.I. Pigment Yellow 83 (® Novoperm Yellow HR02, |
| | | Clariant GmbH, component A) |
| 8 | parts | dispersant specimen 1 (component B) |
| 2 | parts | alkylpolyalkylene glycol ether (component C) |
| 9.5 | parts | polyethylene glycol, molecular weight 200 g/mol |
| | | (component E) |
| 0.5 | part | defoamer (component H) |
| 0.2 | part | preservative (component J) |
| 39.8 | parts | demineralized water (component K) |

For the production and testing of the pigment preparation the procedure set out in Example 1 was repeated. After a week of storage at 60° C. the pigment preparation was liquid, homogeneous, and foam-free. The viscosity of the pigment preparation was 210 mPa·s.

### Example 5

| | | |
|---|---|---|
| 40 | parts | C.I. Pigment Red 146 (® Permanent Carmine FBB02, |
| | | Clariant GmbH, component A) |
| 4 | parts | dispersant specimen 5 (component B) |
| 2 | parts | alkylpolyalkylene glycol ether (component C) |
| 9.5 | parts | polyethylene glycol, molecular weight 200 g/mol |
| | | (component E) |
| 0.5 | part | defoamer (component H) |
| 0.2 | part | preservative (component J) |
| 43.8 | parts | demineralized water (component K) |

For the production and testing of the pigment preparation the procedure set out in Example 1 was repeated. After a week of storage at 60° C. the pigment preparation was liquid, homogeneous, and foam-free. The viscosity of the pigment preparation was 80 mPa·s.

### Example 6

| | | |
|---|---|---|
| 60 | parts | C.I. Pigment Red 102 (® Bayferrox Red 130, Lanxess AG, |
| | | component A) |
| 9 | parts | dispersant specimen 6 (component B) |
| 1 | part | alkylpolyalkylene glycol ether (component C) |
| 0.5 | part | defoamer (component H) |
| 0.2 | part | preservative (component J) |
| 29.3 | parts | demineralized water (component K) |

For the production and testing of the pigment preparation the procedure set out in Example 1 was repeated. After a week of storage at 60° C. the pigment preparation was liquid, homogeneous and foam-free but slightly thixotropic. The viscosity of the pigment preparation was 620 mPa·s.

### Example 7

| | | |
|---|---|---|
| 30 | parts | C.I. Pigment Blue 15:3 (® Hostaperm Blue B2G, Clariant |
| | | GmbH, component A) |
| 15 | parts | dispersant specimen 4 (component B) |
| 1 | part | alkylpolyalkylene glycol ether (component C) |
| 20 | parts | propylene glycol (component G) |
| 0.2 | part | preservative (component J) |
| 33.8 | parts | demineralized water (component K) |

The pigment preparation was produced in the same way as for Example 1. The pigment preparation was stored at 50° C. for 4 weeks and inspected. The viscosity was determined using a Haake cone/plate viscometer (Roto Visco 1) at 20° C. (titanium cone: Ø 60 mm, 1°), the viscosity being investigated as a function of the shear rate in a range between 0 and 200 s⁻¹. The viscosities were measured at a shear rate of 60 s⁻¹.

The pigment preparation possessed a high color strength and did not foam. After storage at 50° C. for four weeks, the pigment preparation was liquid and homogeneous. The viscosity of the pigment preparation was 500 mPa·s.

### Example 8

| | | |
|---|---|---|
| 30 | parts | C.I. Pigment Blue 15:3 (® Hostaperm Blue B2G, Clariant |
| | | GmbH, component A) |
| 15 | parts | dispersant specimen 3 (component B) |
| 1 | part | alkylpolyalkylene glycol ether (component C) |
| 20 | parts | propylene glycol (component G) |
| 50.2 | parts | preservative (component J) |
| 29.8 | parts | demineralized water (component K) |

For the production and testing of the pigment preparation the procedure set out in Example 7 was repeated. The pigment preparation possessed a high color strength and did not foam. After storage at 50° C. for four weeks the pigment preparation was liquid and homogeneous. The viscosity of the pigment preparation was 420 mPa·s.

### Example 9

| | | |
|---|---|---|
| 30 | parts | C.I. Pigment Blue 15:3 (® Hostaperm Blue B2G, Clariant |
| | | GmbH, component A) |
| 15 | parts | dispersant specimen 5 (component B) |
| 20 | parts | propylene glycol (component G) |
| 5 | parts | amphoteric surfactant (component H) |
| 0.2 | part | preservative (component J) |
| 29.8 | parts | demineralized water (component K) |

For the production and testing of the pigment preparation the procedure set out in Example 7 was repeated. The pigment preparation possessed a high color strength and did not foam. After storage at 50° C. for four weeks the pigment preparation was liquid and homogeneous. The viscosity of the pigment preparation was 540 mPa·s.

1. An aqueous pigment preparation comprising
(A) at least one organic, inorganic pigment or a mixture thereof,
(B) at least one dispersant comprising 2 or more structural units of the formula I 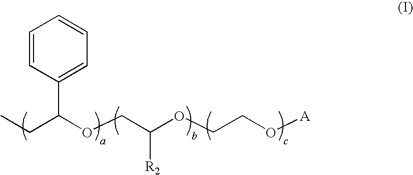
which are attached to a structural unit Y, and wherein
a is an integer from 1 to 100,
b is an integer from 0 to 100,
c is an integer from 1 to 100,
and the units a, b, and c are, optionally, arranged randomly or blockwise,
R₂ is an aliphatic, linear or branched hydrocarbon radical having 1 to 30 carbon atoms,
A is hydrogen or an anionic radical of the formulae —SO₃M, —SO₂M, —PO₃M₂, —CH₂COOM or (II), and 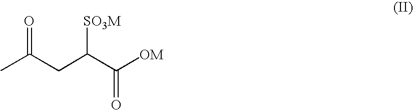
M is a hydrogen atom, a cation selected from the group consisting of Na⁺, K and NH₄⁺, ethanolammonium, diethanolammonium, triethanolammonium, or a secondary, tertiary or quaternary, alkyl-substituted ammonium ion, or a combination thereof,
the structural unit Y being a carbon-containing structural unit capable of alkoxylation at not less than two bond sites, and the not less than two bond sites are formed by one or more nitrogen atoms, one or more oxygen atoms, or both.

2. The composition as claimed in claim 1, wherein the structural unit Y is selected from the group consisting of dihydric or polyhydric alcohols, amines having at least one amino group, and from amino alcohols containing at least one amino group and at least one OH group.

3. The composition as claimed in claim 2, wherein the structural unit Y is derived from a compound containing 2 to 30 amino groups, OH groups or both.

4. The composition as claimed in claim 1, wherein the at least one dispersant is of the formula III
X—Y—X (III)
and wherein Y is selected from structural units of the formulae IV to XIV 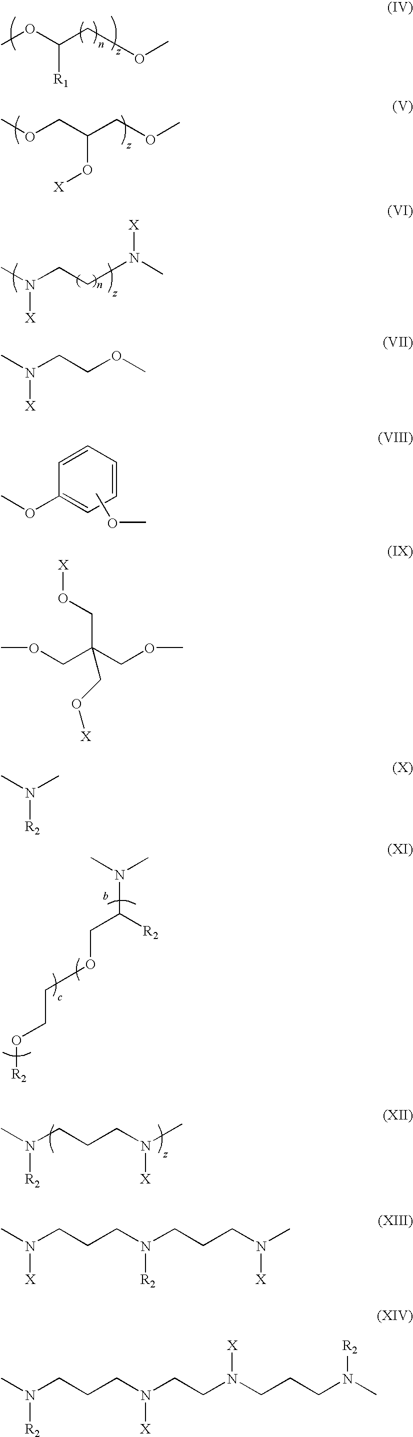
wherein
R₁ is an aliphatic, linear or branched hydrocarbon radical having 1 to 30 carbon atoms, or a hydrogen atom,
z is an integer greater than or equal to 1,
n is an integer from 1 to 30, and
X is a radical of the formula I.

5. The composition as claimed in claim 1, wherein a is a number from 1 to 10, b is zero and c is a number from 5 to 30.

6. The composition as claimed in claim 5, wherein n is an integer from 2 to 4.

7. The composition as claimed in claim 1, wherein M is sodium, potassium, ammonium, ethanolammonium, triethanolammonium or trimethylammonium.

8. The composition as claimed in claim 1, containing 3% to 80% by weight of the at least one organic, inorganic pigment or mixture thereof.

9. The composition as claimed in claim 1, containing 0.1% to 30% by weight of the at least one dispersant.

10. The composition as claimed in claim 1, further comprising up to 30% by weight of a nonionic surfactant.

11. The composition as claimed in claim 1, further comprising up to 30% by weight of an anionic surfactant.

12. The composition as claimed in claim 1, further comprising up to 50% by weight of a polyethylene glycol ether having an average molar mass between 200 and 2000 g/mol.

13. The composition as claimed in claim 1, further comprising up to 50% by weight of a polyethylene glycol monoalkyl ether having an average molar mass between 200 and 2000 g/mol and an alkyl radical of 1 to 6 carbon atoms.

14. The composition as claimed in claim 1, further comprising 0% to 30% by weight of an organic solvent or a hydrotropic substance.

15. The composition as claimed in claim 1, further comprising up to 10% by weight of at least one additive.

16. The composition as claimed in claim 1, further comprising up to 2% by weight of a preservative.

17. A dispersant for dispersing at least one organic, inorganic pigment or a mixture thereof in water, comprising at least one dispersant comprising 2 or more structural units of the formula I 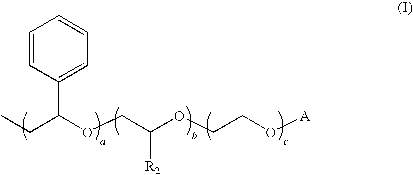
which are attached to a structural unit Y, and wherein
a is an integer from 1 to 100,
b is an integer from 0 to 100,
c is an integer from 1 to 100,
and the units a, b, and c are, optionally, arranged randomly or blockwise,
R₂ is an aliphatic, linear or branched hydrocarbon radical having 1 to 30 carbon atoms,
A is hydrogen or an anionic radical of the formulae —SO₃M, —SO₂M, —PO₃M₂, —CH₂COOM or (II), and 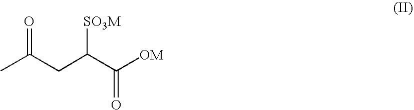
M is a hydrogen atom, a cation selected from the group consisting of Na⁺, K and NH₄⁺, ethanolammonium, diethanolammonium, triethanolammonium, or a secondary, tertiary or quaternary, alkyl-substituted ammonium ion, or a combination thereof,
the structural unit Y being a carbon-containing structural unit capable of alkoxylation at not less than two bond sites, and wherein the not less than two bond sites are formed by one or more nitrogen atoms, one or more oxygen atoms, or both.

18. A method of dispersing at least one organic, inorganic pigment or mixture thereof in water, comprising the step of adding at least one dispersant (B) to the at least one organic, inorganic pigment or mixture thereof in water, wherein the at least one dispersant (B) comprises at least one dispersant comprising 2 or more structural units of the formula I 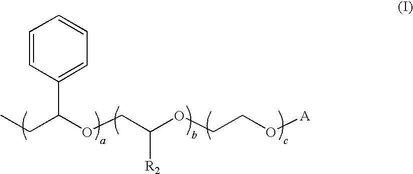
which are attached to a structural unit Y, and wherein
a is an integer from 1 to 100,
b is an integer from 0 to 100,
c is an integer from 1 to 100,
and the units a, b, and c are, optionally, arranged randomly or blockwise,
R₂ is an aliphatic, linear or branched hydrocarbon radical having 1 to 30 carbon atoms,
A is hydrogen or an anionic radical of the formulae —SO₃M, —SO₂M, —PO₃M₂, —CH₂COOM or (II), and 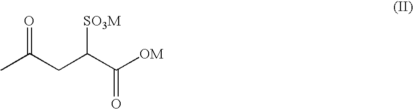
M is a hydrogen atom, a cation selected from the group consisting of Na⁺, K and NH₄⁺, ethanolammonium, diethanolammonium, triethanolammonium, or a secondary, tertiary or quaternary, alkyl-substituted ammonium ion, or a combination thereof,
the structural unit Y being a carbon-containing structural unit capable of alkoxylation at not less than two bond sites, and the two bond sites are formed by one or more nitrogen atoms, one or more oxygen atoms, or both.

19. A dispersant comprising 2 or more structural units of the formula I 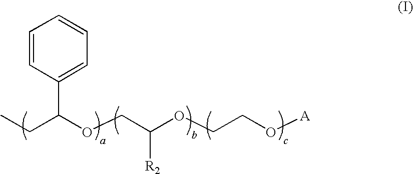
which are attached to a structural unit Y, and in which
a is an integer from 1 to 100,
b is an integer from 0 to 100,
c is an integer from 1 to 100,
and the units a, b, and c are, optionally, arranged randomly or blockwise,
R₂ is an aliphatic, linear or branched hydrocarbon radical having 1 to 30 carbon atoms,
A is hydrogen or an anionic radical of the formulae —SO₃M, —SO₂M, —PO₃M₂, —CH₂COOM or (II), and 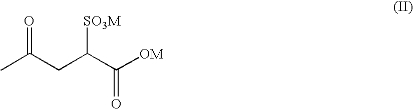
M is a hydrogen atom, a cation selected from the group consisting of Na⁺, K and NH₄⁺, ethanolammonium, diethanolammonium, triethanolammonium, a secondary, tertiary or quaternary, alkyl-substituted ammonium ion, or a combination thereof,
the structural unit Y being a carbon-containing structural unit capable of alkoxylation at not less than two bond sites, and wherein the not less than two bond sites are formed by one or more nitrogen atoms, one or more oxygen atoms, or both.
